(19) United States
(12) Patent Application Publication
(10) Pub. No.: US 2017/0284618 A1
(43) Pub. Date: Oct. 5, 2017

(54) TABLE WITH ATTACHED LIGHT AND EMBEDDED CONTROLS

(71) Applicant: Margaux Reynolds, Studio City, CA (US)

(72) Inventor: Margaux Reynolds, Studio City, CA (US)

(21) Appl. No.: 15/374,954

(22) Filed: Dec. 9, 2016

Related U.S. Application Data
(60) Provisional application No. 62/265,400, filed on Dec. 9, 2015.

(51) Int. Cl. F21S 8/00; F21V 21/00; F21V 19/00

(52) U.S. Cl. CPC F21S 8/03; F21V 19/00; F21V 21/00; F21S 8/00; F21V 17/00

(57) ABSTRACT

A table that includes a planar upper surface having a recess, a lamp positioned in the recess, a first sensor, and an embedded touch control. The lamp can be in a closed position or a raised position, and have a first section and a second section. The first section is attached to the planar upper surface at an end thereof. The first sensor detects the position of the lamp and controls the lamp based on the position of the lamp. The embedded touch control is located beneath the planar upper surface, and controls the light level of the lamp.

### BACKGROUND

Furniture has been designed with sensors for controlling electrical devices. For example, the cabinet described in US Patent Publication No. 20130249568 includes illuminated touch controls. Airline furniture as described in US Patent Publication No. 20140246300 has also been designed to include electronic switches. There remains a need, however, for improved furniture designs.

### FIGURES

FIG. 1 illustrates an embodiment of a table top according to the present invention.

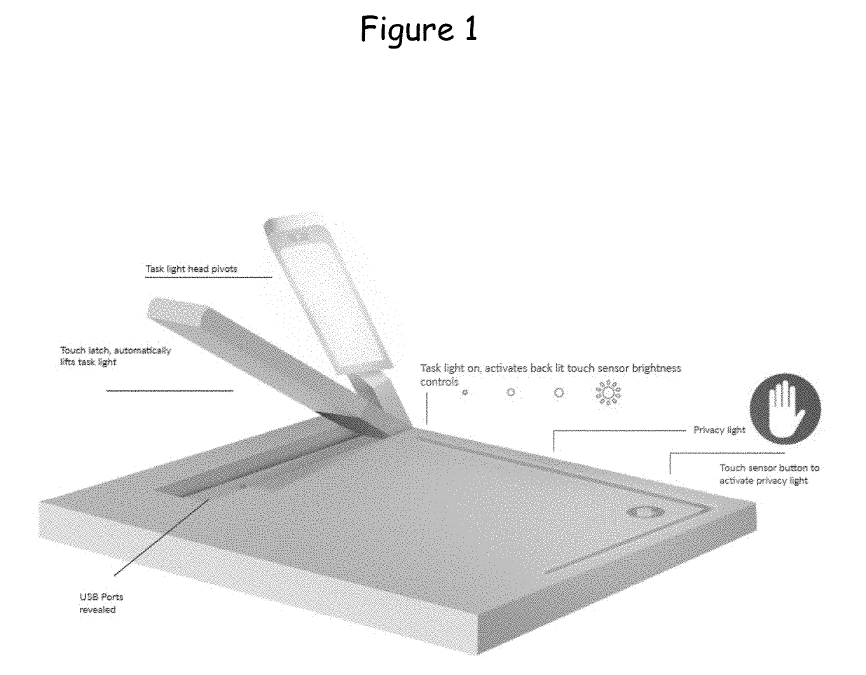

FIG. 2 illustrates the incorporation of the table top of FIG. 1 into a work table, either as a single unit or in a modular fashion (i.e. multiple table top units in one piece of furniture).

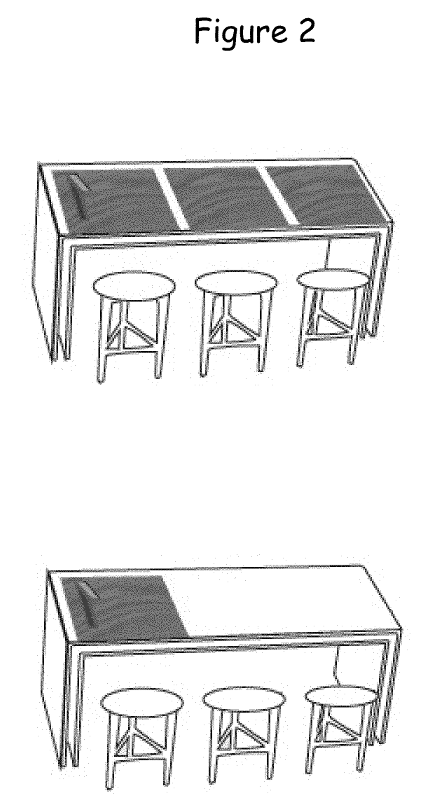

### SUMMARY

The present invention comprises a table with a light fixture attached at one end to the table by a hinge. The light is activated upon actuation of the hinge, i.e. upon lifting up the unattached end of the light. As used herein, the term “table” is intended to refer to a piece of furniture with a substantially planar upper surface which provides a rigid surface on which objects may be placed.

Upon activation of the light, indicator lights become visible on the upper surface of the table. Sensors which control the light level of the lamp are co-located with the indicator lights. Both the indicator lights and sensors are underneath the upper surface of the table, in order to provide a maximum amount of usable, planar surface area on the table.

### DESCRIPTION

Desktop Features

The desktop looks like a plain surface from the user side. On the opposite side of the surface we rastered (laser etched) the iconography of the controls. By rastering with a laser, you are cutting into/making the surface thinner, in order to create the line-work. The depth of the rastering was determined by the constraint that it could not be visible from the front side, but had to be able to pass light through clearly. The design also had to be etched backwards, because it was etched to the opposite side of the surface than where it appears. The closer the LED light is placed beneath this surface, the brighter it is with less energy exerted. On the back, we also painted around the rastered design with black paint to prevent light from spilling through around the design, which would make it appear “blurry.”

In the embodiments illustrated below, beneath the Maple veneer is an MDF piece (essentially a hollow box) which houses the electronics and is open on the back side to allow access to the electronics. Medium density fiberboard (MDF) is a high grade, composite material that performs better than solid wood in many areas. Made from recycled wood fibers and resin, MDF is machine dried and pressed to produce dense, stable sheets. Any thin, opaque material that is not conductive (no metal) or translucent (no glass or clear plastic) can be used in place of MDF, for example painted solid laminate, wood veneer, opaque acrylic, or plastic. The material should be non-conductive and can be covered with veneer.

From the front, a place is cut out for the touch control electronics (LED and capacitance sensors) so that they are housed right beneath the veneer. There is also a cut out for the task light to fit into the desk so that the it lies flush with the desk top when down. This entire MDF piece was covered with veneer, so that there is an illusion that this is one solid piece of maple, with the task light piece cut out and installed as a separate piece that lifts.

To raster the back side of the wood, I used a method of laser etching for the icons/controls design, because the thinner the surface is, the more light can penetrate the area. Alternatively, any other any method, where the design or line-work by comparison is thinner or more transparent than what surrounds it, so that light can penetrate only the areas of the icon artwork could be used (any technology that can etch, you could also paint, print the artwork on the back, though this may be less effective.) Designing the iconography into the LED electronics scheme or creating the design on an additional, intermediate layer that lies beneath the surface wouldn't be effective enough. The surface itself needs to be treated and here is why: The design has to have high enough resolution to be crisp, clear and visible from the front side. The farther away the design is from the surface, the lower the resolution of the design from the front side, so the desktop surface itself (the wood veneer) has to be treated.

Electronics are placed beneath the desktop surface. The desk top controls needed to be simultaneously touch-sensitive and LED back-lit through the veneer. As previously stated, the veneer has been rastered with the design that the LED will shine through to create the iconography for the sensors. Just beneath the veneer, surrounding the rastered area, there is a thin layer of conductive metal (copper was used, although any conductive metal could be used) outlining the area that will be touch responsive. The “touch sensitive” area is made of three layers:
Veneer with the bottom side rastered to reflect the icons that will appear
Below that, a thin layer of copper or conductive material that is hollow in the center.
Below that, aligned so that an LED light shines through the center of each hollow square in the copper is a strong LED light strip.

The LED, when activated will shine up through the area outlined by the conductive metal and through the rastered area of the veneer to create a glowing icon on the surface of the desk. The conductive metal areas are connected via wires to small circuits that detect capacitive changes in the metal and generate a binary signal (“high” or “low”) on another wire that can be interpreted by a microprocessor. When a hand touches the illuminated icon, the there is a change in the capacitance detected in the conductive metal just beneath that area of the veneer, which the circuit detects and sends a signal “high” on another wire to the microprocessor. That information can be used to then trigger an action based on what icon was activated by the user, such as increasing decreasing the desk lamp brightness. The user sees icons illuminated on the desk top upon lifting the task light and by dragging their finger along the area where these “controls” appear, the user effects the brightness of the task light.

In the illustrated design, we produced 4 “capacitance sensors” lined up linearly that correspond to the 4 icons rastered into the wood above it. Though the number of sensors, icons, position and placement is specific only to this example. All of this is variable depending on the design.

The centers of the capacitance (copper) sensors were hollowed out to allow the LED to shine through, in order for it to both be able to pass light through it and have enough conductive material to be able to detect capacitance exactly where the icons appeared (where the LED was illuminating), which indicated to the user where to touch the sensor. LED brightness will depend on how far away the light sits from the surface. Since the LED has metal on it and is conductive, if it sits too close to the capacitance sensor, the metal from the LED or from the metal in the wires that go to and from an LED will trigger the sensors. Thus, simply surrounding the LED with copper tape to create a capacitance sensing area would cause the sensor to be ‘always activated’ as it would be detecting the LED/wires. The present invention overcomes this by ‘sinking’ the LED/wires into a small hole beneath the veneer and keeping the copper tape or other conductive material right behind the veneer, thus creating a distance between the LED/wires and the copper tape so that the rastered area can still be capacitance-sensitive while benefiting from the LED ‘back lighting’ the specific sensor area, allowing the user to know where to touch.

One of the most important aspects of the desk, is the ability for the appearance of the controls to reappear and disappear through interaction. This gives the appearance of a traditional desk when not in use. In this case, the task light turns on/off, triggering the desktop controls to appear. Upon raising and lowering the task light, the hall effect sensor sends its signal to the microprocessor, which then either turns on or off the task light and the touch-sensor back-lights beneath the desk, based on whether the task light is up or down. The microprocessor determines whether or not the task light is up based on the signal coming from the hall effect sensor. When it detects that the task light is up it turns on the desk lamp at the starting setting and turns on the LEDs under the touch sensors to illuminate them. When it detects that the task light is down it turns off both the task light and the LEDs under the touch sensors/desk surface and ignores any further input from the touch sensors (since the task light is now off). Thus the desk returns to a “normal desk” state. All adjustments in the LED brightness or on/off status are done via pulse-wave modulation and transistors controlling the electrical input to the LEDs. The system preferably plugs into a standard wall outlet and a AC-to-DC converter converts the electricity to DC which then powers the LEDs and microprocessor.

Task Light Feature

The upper surface of the lamp is preferably co-planar with the upper surface of the desk when it is in the down/off position. By lifting the free end of the light, the user reveals the task light. In one embodiment, the task light can include a lift mechanism, for example a touch latch (catch and strike plate) and a 180 degree torsion spring. In this embodiment, the user would press the front of the light, causing it to lift through the action of the spring and to turn on. Preferably, there is no on/off switch to this light, and the light turns on by lifting it.

The light preferably rotates as well as moving up and down. To do this, the task light can be separated into two halves. The bottom half (non-rotating piece) is fixed to the desk and is confined to only moving up and down at the hinge when the user raises the light. The top half (rotating piece) houses the light array. A pivot point part can allow for the top to rotate from the bottom and pass concealed wires through both halves and prevent the top half from being disconnected from its lower half. The part can be machined from an aluminum part that is hollow in the center (for wire to pass through) and had two grooves in it. Two set screws are attached to the top and bottom halves of the task light, sit in these two grooves, allowing for 360 degree rotation, (the screws run along the grooves like a track) while keeping both halves of the task light from being disconnected if pulled on.

The task light is connected to the desk and rises and falls at a hinge point, where a hole in the side both the task light and the desk is drilled and a rod goes through as an axis point. The concealed wires run from the task light into the desk through this point, without being visible. We used a hollow rod at the hinge to allow for the desk to rise and lower and for the wires to snake through from the task light to the desk. The desk piece houses the main circuitry boards.

In addition to having the head rotate, for a better lighting angle, I positioned the LED strip to sit on an angle. The task light head is made up of ½ Maple and ½ Clear acrylic (although any clear material that is light weight is more ideal than heavy acrylic) I cut the task light top in half at the diagonal and made it one half acrylic and the other half maple.

Preferably, there are hidden magnets built into the task light and a Hall effect sensor in the desk. They are lined up with the sensor so that they meet when the task light is down, which turns off the light. When the task light is lifted, the magnets separate from the Hall effect sensor and the light turns on. This also triggers the LED light for the desk top controls to turn on, establishing the relationship between the task light and the touch sensitive icons/capacitance controls that now appear on the desk, which were previously hidden when the task light was flush with the surface. When the task light is lowered into it's original position, the magnets align with the Hall effect sensor and everything turns off.

In another alternative, the light can be made to turn on by lifting it without the mechanism, i.e physically lifting it. The task light could be hidden in another way in the desk. This would be accomplished in any way that allows two scenarios for the light: where the light can be part of the desk/off in one scenario and differentiated in some way from the desk—raised up/on in the other scenario. An alternative to the Hall effect sensor could be a Reed switch or a dead man's switch. LEDs are efficient, low power lighting solutions so they are ideal for light beneath the desktop, however the task light could use other types of lighting arrays.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

### CROSS-REFERENCE TO RELATED APPLICATIONS

This application claims the benefit of priority of U.S. Patent No. 62/265,400, filed Dec. 9, 2015.

### EXAMPLES

Desk top

To accommodate the light feature, the desktop, (in this prototype—a ¼″ piece of MDF) is laser cut in two places: one square section is removed for the task light to be house in, so that it sits lush with the desk top and one square section was removed for the capacitace sensor where the copper material is covering below

Capacitance buttons are made up of a series of copper (Conductive material) squares with the center cut out to let the LED pass through. The size of the cut out within each copper square is arbitrary, but accommodates the thickness of the LED strip. Space must be included in between each separate copper square in order for the capacitance sensor to recognize each copper section as a separate button, otherwise it would register as one big button. As shown in the picture, this copper section sits on top of the desktop, right above the cut out, but is covered by the veneer. The space between each sensor is covered to prevent the LED light from the strip from spilling into the non-button sections.

LED Strip

This sits below the desktop layer (¾″) altogether and is taped to the back of this layer, sitting over the cut out. The distance between the LED strip and the front veneer is the distance between the back of this layer and the veneer (¾ inch).

Veneer

Paper-backed veneer of Maple wood is rastered on the opposite side with symbols (reversing the order/design because the design is being viewed from the other side) to indicate brightness levels. (4 buttons) The exact depth of the removed of material in this protoype is 0.013 but measurement was not used to achieve this, deciding how deep to cut was based on visual judgment and took several passes on the laser machine to achieve. The determining factors were whether the cut was visible from the front side and also able to effectively pass light.

Front of the veneer in ambient light/Front of the veneer with a large bright light shining right behind it to show the rastered detail (which is why the color of the wood looks different)

I ended up gluing a series of layers of MDF together, when it would be more efficient to have a single piece or two pieces of MDF of the same overall thickness and CNC it from various sides to remove the necessary material. Here is how I did it: The MDF desk top layer is glued to a series of MDF layers with the section removed for the task light housing in order to give it the proper amount of space to lie lat with the top piece (Hole is the material thickness of the light+tolerance/material thickness of veneer). This “hole” is covered with veneer, to give the illusion of a solid piece of Maple. Below these layers the electronics are taped, I used the mill to cut out thin areas for the task light wires and Hall effect sensor to be housed, as they come through the side of the task light area and therefore required channels to run through to this bottom area. Glued to this later is a layer of MDF (¾″) which has mostly been milled out from 4.125″ from the left to 0.5 away from the right. to create essentially a frame: this adds a space to house the electronics and makes the overall piece lighter. From the bottom side is a cut out with a detachable door so that the electronics can be accessed from the back side for repairs. The door is ¼″ thick and there is an area cut out of the same depth to accommodate the door.

Detail/close up photos showing the capacitance sensor wires and the backside of the LED strip set over the cut out in the MDF where the copper material is set within (Light stip sits 0.75″ away from the copper material) Wires are sodered to the copper material and run to a panel, converts capacitance signal into digital (1/0) which goes to the microprocessor, to determine the action from the sensor

Task Light

Measurements specific to this prototype: On the desk top is an area where material is removed measuring 2.125″ wide, 13.5″ high and 0.75″ deep to house the tesk light. The task light's back/where the hinge goes through is rounded, allowing it to rotate along the hinge to be lifted.

In the desk top, a hole is drilled through the side, to allow the task light wires to be tunneled into the electronics area. A hollow metal rod goes through this hole and a matching hole through the back of the task light and the desk top at this area, allowing the task light to rotate and simultaneously snake the wires through.

The task light rotates at the hinge point. It lifts from a rest position when the user presses down on the top/front of the light. This lifting action occurs through a 180 degree torsion hinge and touch latch The photos on the opposite site were from a proof of concept for this mechanism, however due to time, this feature didn't make it into my prototype, but is the way the task light lifts in order to light and would be built into the actual invention.

The touch latch is made up of a strike plate and a catch latch. The strike plate would be fixed to the task light on the side that faces down, on the upper area (the side that sits the highest when lifted). The strike is aligned with the catch, which sits in the recessed area of the desk top. When the task light is down it engages the catch of the touch latch. A hole is milled out, so that the entire body of the touch latch is set within the MDF, exposing only the catch piece. This piece catches the strike plate and holds the light down against the force of the 180 degree torsion hinge, when the task light is down. The user would press the task light to engage. The force of the hinge needed in order to make the light li$ is greater than the weight of the task light, but not too tight to aggressively propel the task light with great force when pressed/released. A housing for the torsion hinge is sunk beneath the top layer and a thin channel is milled to allow the long end of the torsion hinge to travel. Only this thin channel is viewable from the desktop, the body of the torsion spring is installed from the backside.

Touch Latch Mechanism

To make the light easier to use I added a touch latch mechanism to my design.

The mechanism requires a 180 degree torsion hinge to provide tension with enough torque to raise and support the weight of light, as well as a touch latch with a catch and strike plate to catch and hold the light down and resist the force of the torsion hinge until released.

Task Light I Rotating Part

I added a pivot of rotation and had the LED strip sit on an angle. I cut the task light in half at the diagonal angle and made up of ¾″ acrylic and ¾″ maple. This made an A and a B side that line up to form a rectangle upon assembly. I drilled holes in the wood to fit a magnet that corresponded to one built into the desk top to form the Hall Effect Sensor, which activates the light when the task light is lifted.

Wires run from the light source, via an LED strip, through a pivot part and through a hollow hinge at the bottom of the light into the desk top piece and into the bottom where the electonicare installed.

Task Light I Base/Fixed Part

At the base of the moveable task light are two separate halves that have been milled on either side to house a pivot Part and a channel running wires. I drilled two set screws on the same side of both a rotating piece and a non-rotating piece to act as a groove for the pivot part to rotate and to secure the pivot part to keep the rotating light source from being separated. At the pivot point, one half forms with the acrylic/light source and has the ability to rotate, the other half remains stationary and connect to the hinge at the base.

Pivot Part

I machined a pivot part to allow rottion and support the light at that point of rotation, by adding groves in the metal at two points to connect with the set screws through the base and rotational part of the task light and hollowed the center to allow wires to run through. The part was machined on the metal lathe from a ½″ aluminum rod. A ⅛th inch hole was drilled through the part, to run wires from task light.

What is claimed is:

1. A table with an attached light and embedded controls as described herein.
